(19) United States
(12) Patent Application Publication
(10) Pub. No.: US 2024/0239200 A1
(43) Pub. Date: Jul. 18, 2024

(54) ELECTRICAL ARCHITECTURES FOR RECREATIONAL VEHICLES

(71) Applicant: Winnebago Industries, Inc., Eden Prairie, MN (US)

(72) Inventors: Neng Piyabongkarn, Plymouth, MN (US); Stephen Lynn, Ann Arbor, MI (US); Joe Lindeman, Lake Mills, IA (US); Adam Weiland, Britt, IA (US)

(21) Appl. No.: 18/411,276

(22) Filed: Jan. 12, 2024

Related U.S. Application Data
(60) Provisional application No. 63/439,128, filed on Jan. 15, 2023.

(51) Int. Cl. B60L 1/00; B60L 53/22; B60L 58/18; H02J 3/00; H02J 3/02; H02J 7/00

(52) U.S. Cl. CPC B60L 1/006; B60L 53/22; B60L 58/18; H02J 3/0075; H02J 3/02; H02J 7/00047; H02J 2207/20

(57) ABSTRACT

A recreational vehicle includes a body, a chassis electrical system including a first power source, a first port coupled to the first power source and attached to the body such that the first port is accessible from outside the recreational vehicle, a house electrical system including a second power source, a second port coupled to the second power source and attached to the body such that the second port is accessible from outside the recreational vehicle, and a switch assembly electrically coupled between the second port and the second power source and including a controller programmed to switch between charging modes depending on a type of external power source connected to the second port.

### CROSS REFERENCE TO RELATED APPLICATION

This application claims priority to Provisional Application No. 63/439,128, filed Jan. 15, 2023, which is herein incorporated by reference in its entirety.

### SUMMARY

Certain embodiments of the present disclosure describe various systems, subsystems, components, and methods for use with vehicles such as recreational vehicles (e.g., Class A recreational vehicles; Class B recreational vehicles such as camper vans; Class C recreational vehicles; trailers such as travel trailers, toy haulers, and fifth-wheel trailers; and the like).

While multiple embodiments are disclosed, still other embodiments of the present invention will become apparent to those skilled in the art from the following detailed description, which shows and describes illustrative embodiments of the invention. Accordingly, the drawings and detailed description are to be regarded as illustrative in nature and not restrictive.

### BRIEF DESCRIPTION OF THE DRAWINGS

FIG. 1 shows a recreational vehicle, in accordance with certain embodiments of the present disclosure.

FIG. 2 shows a high-level block diagram of a recreational vehicle electrical system, in accordance with certain embodiments of the present disclosure.

FIG. 3 shows a more detailed block diagram of the recreational vehicle electrical system of FIG. 2, in accordance with certain embodiments of the present disclosure.

FIG. 4 shows a schematic of an electrical switch assembly used in the recreational vehicle electrical system of FIGS. 2 and 3, in accordance with certain embodiments of the present disclosure.

FIG. 5 shows a more detailed schematic of an electrical switch assembly of FIG. 4, in accordance with certain embodiments of the present disclosure.

FIGS. 6 and 7 show alternative arrangements of the recreational vehicle electrical system of FIGS. 2 and 3, in accordance with certain embodiments of the present disclosure.

FIG. 8 shows a block diagram of a computing device (e.g., controller) for carrying out functions described herein, in accordance with certain embodiments of the present disclosure.

While the disclosure is amenable to various modifications and alternative forms, specific embodiments have been shown by way of example in the drawings and are described in detail below. The intention, however, is not to limit the disclosure to the particular embodiments described but instead is intended to cover all modifications, equivalents, and alternatives falling within the scope the appended claims.

### DETAILED DESCRIPTION

Vehicles such as recreational vehicles can utilize multiple power sources to meet user demands. For self-propelled recreational vehicles, one power source (e.g., an internal combustion engine or a set of battery packs) can be used to generate power to propel the vehicle and also supply power to components of a chassis electrical system (e.g., brake lights, headlights, dash lights, dash air-conditioning). A separate power source can be used to supply power to components of a house electrical system (e.g., refrigerator, heating-ventilation-and-air-conditioning (HVAC) systems, house lighting).

Embodiments of the present disclosure are directed to house electrical systems powered by rechargeable batteries. Certain embodiments utilize a dedicated charging port for recharging the batteries of the house electrical system. The charging port can allow for rapid charging from a variety of external power sources such as shore power, home power, or electric vehicle charging stations. For example, the charging port can be a J1772 port (e.g., SAE J1772 electric vehicle charging port) that couples to a J1772 connector and that receives power from 120 volt AC or 240 volt AC power sources. The batteries of the house electrical system can also be charged by solar panels and/or power sources (e.g., batteries, engine) from the chassis electrical system.

Certain embodiments also feature a power switching assembly that helps manage power received from a variety of types of external power sources (e.g., 120 volt power sources, 240 volt power sources) to charge the batteries of the house electrical system. For example, when multiple external power sources are coupled to the switching assembly, a controller of the switching assembly can prioritize which external power source is used to charge the batteries of the house electrical system.

The house electrical system can provide power to components of the system itself as well as components external to the system. For example, the batteries of the house electrical system can be used to provide power to batteries of the chassis electrical system to extend the driving range of the propulsion system or even provide emergency power to a house (e.g., during a blackout).

### Recreational Vehicles

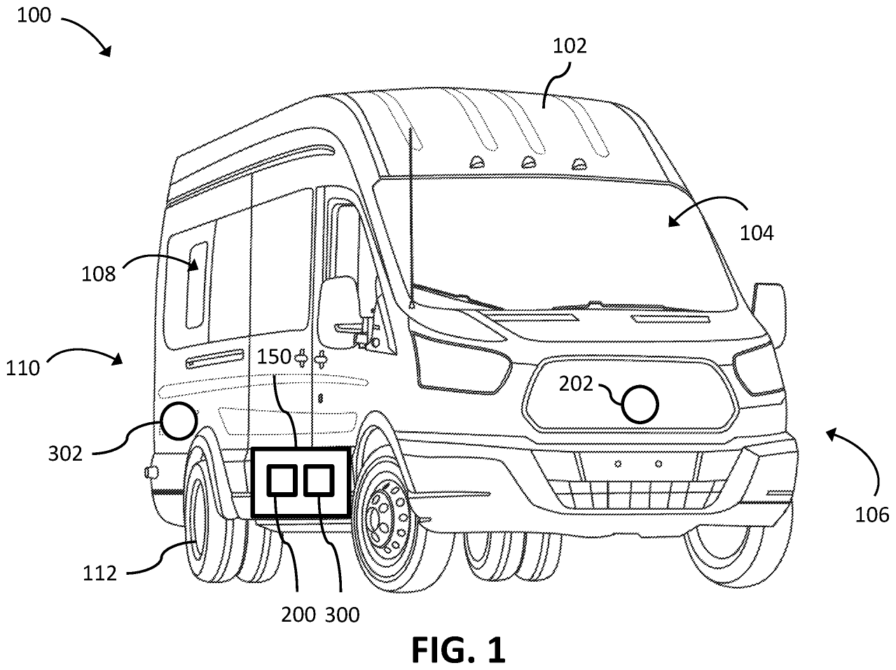

FIG. 1 shows a recreational vehicle 100 having a body 102 that houses a cab area 104 at a front end 106 of the recreational vehicle 100 and a living space area 108 positioned between the cab area 104 and a rear end 110 of the recreational vehicle 100. Although FIG. 1 shows what is typically referred to as a Class B recreational vehicle or a camper van, embodiments of the present disclosure can be used in other types of self-propelled recreational vehicles (e.g., Class A recreational vehicles, Class C recreational vehicles, and the like) and towed recreational vehicles (e.g., 5th wheel trailers, travel trailers, toy haulers, and the like). For example, although a towed recreational vehicle may not have its own propulsion system (e.g., an engine), such recreational vehicles may have a house electrical system, as described below.

The recreational vehicle 100 includes a recreational vehicle electrical system (described in more detail below and represented by block 150 for simplicity of illustration) that includes a chassis electrical system 200 and a house electrical system 300. The systems 200 and 300 can be considered subsystems of the overall recreational vehicle electrical system 150.

The chassis electrical system 200 includes at least part of a propulsion system that provides electricity to components and/or rotates one or more of the wheels (e.g., by rotating axles or by directly rotating the wheels). For example, one or more power sources can provide the energy to rotate the axle(s) and/or wheels and therefore propel the recreational vehicle 100. In certain embodiments, the power source includes one or more rechargeable batteries (e.g., lithium-ion battery cells), fuel cells, an engine, or a combination (e.g., hybrid). In embodiments where the recreational vehicle 100 is at least partially powered and propelled by electricity created by batteries, the batteries can be distributed throughout the recreational vehicle 100.

The chassis electrical system 200 can include a first port 202 (e.g., an electrical charging port) for refueling or charging the one or more power sources. The first port 202 can be positioned on the front end 106 of the recreational vehicle 100 and be accessible from outside the recreational vehicle 100. For example, the first port 202 can be located within a front grill portion of the recreational vehicle 100. In embodiments where the power source is an internal combustion engine, the first port 202 can be a port for supplying gasoline to a gas tank of the recreational vehicle 100. In such embodiments, the first port 202 may be positioned at a location different than that shown in FIG. 1, such as on a passenger or driver's side of the recreational vehicle 100.

The chassis electrical system 200 can include electrical components such as brake lights, headlights, dash lights, dash air-conditioning, windshield wiper motors, steering, etc. that are powered by the one or more power sources of the chassis electrical system 200.

The house electrical system 300 includes its own power sources (e.g., rechargeable batteries), which provide power to electrical components and systems such as appliances (e.g., refrigerator, microwave), heating-ventilation-and-air-conditioning (HVAC) systems, house lighting, AC outlets, DC components, etc. The house electrical system 300 includes a second port 302 (e.g., an electrical charging port) for charging the one or more power sources. The second port 302 can be positioned on a part of the body 102 away from the first port 202 and be accessible from outside the recreational vehicle 100. For example, the second port 302 can be located on driver's side or passenger's side of the recreational vehicle 100 such that a user can use an electric vehicle charging station to charge the one or more power sources of the house electrical system 300.

### Electrical System Architectures

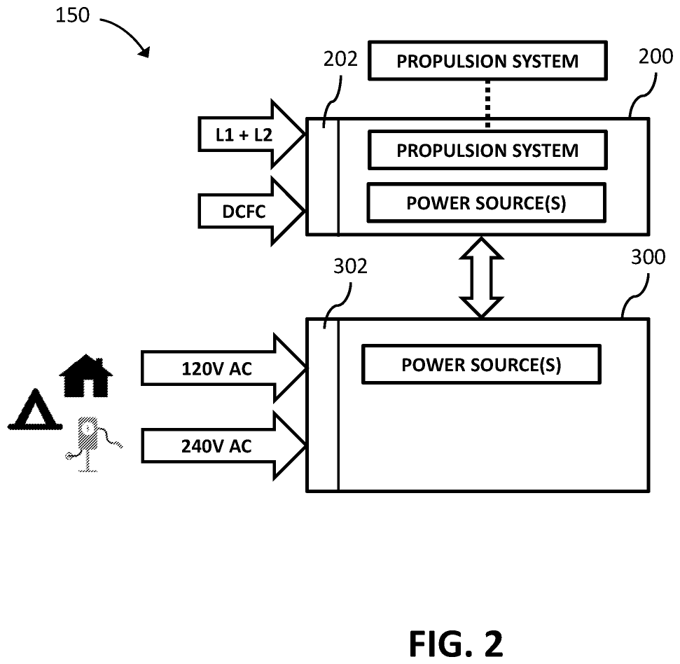

FIG. 2 shows a block diagram of the recreational vehicle electrical system 150. As noted above, the recreational vehicle electrical system 150 includes the chassis electrical system 200 and the house electrical system 300 each with their own respective ports 202 and 302.

The first port 202 can accommodate different types of charging connectors (or plugs). For example, the first port 202 can be used with level 1, level 2, and/or DC fast charger (DCFC) connectors. As such, the first port 202 can be used directly with level 1, level 2, and DCFC charging stations. Further, a mobile charger (or similar device) can be used so that the first port 202 can accept power from a home outlet (e.g., 120V AC power source) or an outlet at a campground (e.g., shore power). The mobile charger can include a standard 120V AC plug on one end and a level 1 connector on the other end with electronics therebetween to convert the 120V A/C power to an acceptable level 1 charging capability. The first port 202 is used to directly charge the power source(s) of the chassis electrical system 200.

In certain embodiments, the second port 302 accommodates only a single type of connector such as a J1772 connector (e.g., a 5-pin connector also referred to as a J plug or Type 1 connector)—although, in such embodiments, the second port 302 can accommodate multiple types of power sources. For example, the second port 302 can accommodate a 120 volt AC power source (e.g., a 120 volt, 30 amp power source) and/or a 240 volt AC (e.g., a 240 volt, 50 amp power source). In other embodiments, the second port 302 can accommodate more than a single type of connector. The second port 302 is used to directly charge the power source(s) of the house electrical system 300.

As such, the recreational vehicle 100 includes a dedicated charging port for the chassis electrical system 200 and another dedicated charging power for the house electrical system 300. As a result, the power sources of the house electrical system 300 can be independently charged (e.g., separately charged from the power sources of the chassis electrical system 200). This allows for rapid charging of the power sources of the house electrical system 300 using a variety of external power sources (e.g., shore power such as 30-amp shore power and/or charging stations such as level 2 charging stations).

In certain embodiments, the chassis electrical system 200 and the house electrical system 300 can share power to each other from their respective power sources. For example, the batteries of the house electrical system 300 can be used to provide power to batteries of the chassis electrical system 200 to extend the driving range of the propulsion system. In another example, the batteries of the house electrical system 300 can be used to provide emergency power to a house (e.g., during a blackout).

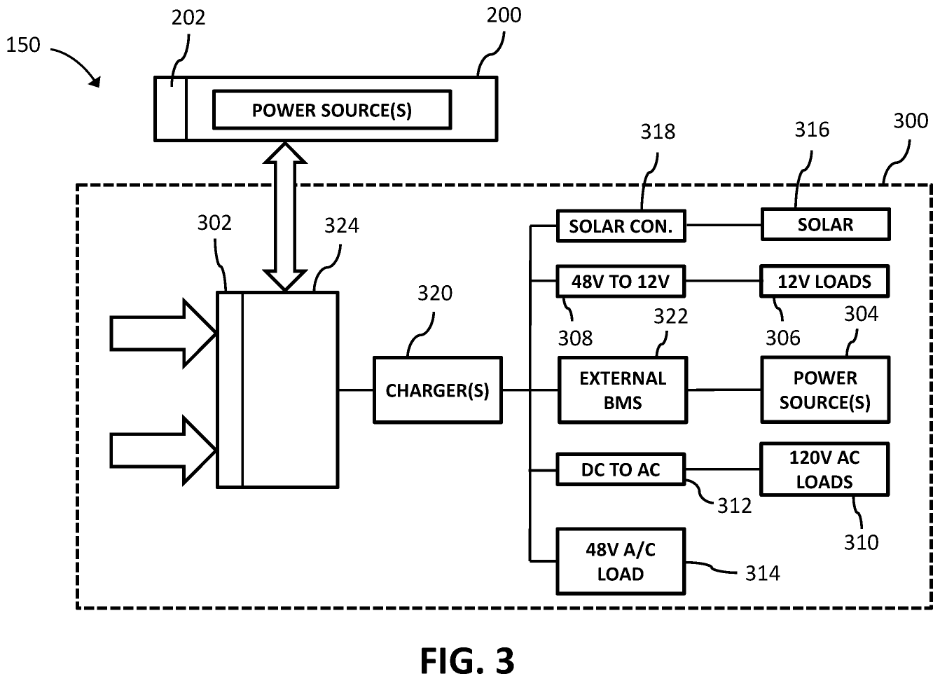

FIG. 3 shows a more detailed diagram of the recreational vehicle electrical system 150. The power sources 304 supply power to various types of loads (e.g., electronics) connected to the house electrical system 300 and can receive power from a variety of external power sources. Although particular voltage levels for the power sources and loads are described below, other voltage levels could be utilized with the recreational vehicle electrical system 150. For example, standard voltage levels can vary from geographical region to region.

As one example of a type of load, the power sources 304 can supply power to 12 volt DC loads 306 (e.g., 12 volts+/−3 volts) such as lighting, fans, etc., within the recreational vehicle 100. If the power sources 304 are rated at a higher voltage than 12 volts, the house electrical system 300 can include a converter 308 such as a 48V-to-12V converter to step down (or convert) the voltage from the power sources 304 to the 12 volt DC loads 306. The converter 308 would be positioned between the power sources 304 and the 12 volt DC loads 306. If the power sources 304 are rated at 12 volts (e.g., 12 volts +/−3 volts), the converter 308 may not be needed to power the 12 volt DC loads 306.

As another example of a type of load, the power sources 304 can supply power to 120 volt AC loads 310 (e.g., 120 volts+/−12 volts) within the recreational vehicle 100. The 120 volt AC loads 310 can connect to outlets that are positioned throughout the recreational vehicle 100 and that can power electronics that require AC power such as coffee makers, televisions, microwaves, computer power supplies, etc. A DC-to-AC inverter 312 converts the DC power to AC power. The inverter 312 is positioned between the power sources 304 and the 120 volt AC loads 310.

As another example of a type of load, the power sources 304 can supply power to 48 volt DC loads 314 (e.g., 48 volts+/−8 volts). In the example of FIG. 3, one of the loads 314 is a 48 volt air conditioning unit. If the power sources 304 are rated for supplying 48 volts (e.g., 48 volts+/−8 volts), the house electrical system 300 does not require a converter between the power sources 304 and the 48 volt DC loads 314.

The power sources 304 of the house electrical system 300 can be charged by various means.

As one example, the house electrical system 300 can include one or more solar panels 316. When the solar panels 316 produce electricity, the solar panels 316 can transmit the electricity to the power sources 304. The house electrical system 300 may include a solar charge controller 318—positioned between the solar panels 316 and the power sources 304—that helps manage the electricity generated by the solar panels 316.

As another example, the house electrical system 300 can include one or more chargers 320, which are described in more detail below. The chargers 320 help manage the power inputted from the second port 302.

An external battery management system (BMS) 322 monitors the power sources 304 and controls the power sources 304 and other components in the house electrical system 300 to help prevent undesired charging, discharging, temperatures, etc. The external BMS 322 may include a controller programmed to perform the various management functions. In addition to the external BMS 322, the power sources 304 can include or be coupled to internal BMS controllers, which monitor the collection of battery cells within each battery. For example, a battery with four lithium-ion battery cells can include one internal BMS controller to monitor the four cells. If the power sources 304 include multiple sets of four-cell batteries, each set can include its own internal BMS controller. The external BMS 322 and the internal BMS controllers can be communicatively coupled to each other and exchange data and commands.

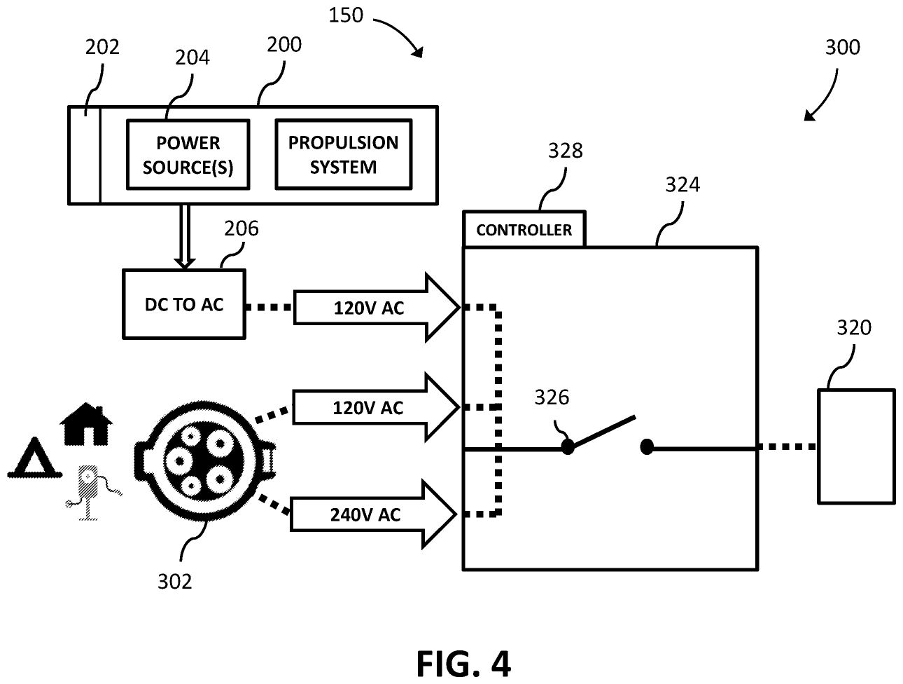

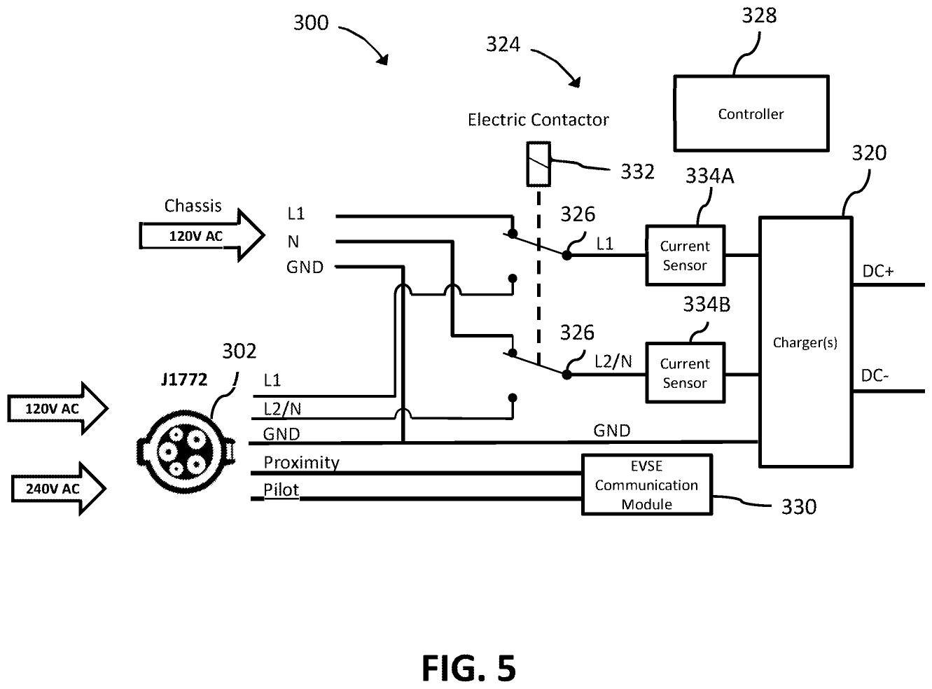

Positioned between the second port 302 and the chargers 320 is a switch assembly 324, which is shown in more detail in FIGS. 4 and 5.

### Switch Assembly

FIG. 4 shows a diagram of the switch assembly 324, which is part of the house electrical system 300. The switch assembly 324 can accommodate input from multiple types of power sources. For example, the switch assembly 324 can receive power-via the second port 302—from a 120 volt AC power source (e.g., shore power at a campground, an outlet at a house) and/or a 240 volt AC power source (e.g., a level 2 charging station or shore power service at a campsite). In certain embodiments, the second port 302 is a 5-pin port such as that represented in FIG. 4.

As another example, the switch assembly 324 can receive power from the power source(s) 204 of the chassis electrical system 200. In this example, the power source(s) 204 would be one or more batteries that are used to power the propulsion system of the recreational vehicle 100 and other features of the chassis electrical system 200. For this input to the switch assembly 324, a DC to AC inverter 206 can be used to convert the DC power generated by the power source(s) 204 to AC power inputted to the switch assembly 324. As such, in the example of FIG. 4, the switch assembly 324 can accommodate a 120 volt AC power source (from the chassis electrical system 200), another 120 volt AC power source (from the second port 302), and/or a 240 volt AC power source (also from the second port 302). Charger 320 can provide both level 1 charging and level 2 charging.

As shown in FIG. 4, the switch assembly 324 includes one or more switches 326 that control which external power source is used to charge the power sources 304 of the house electrical system 300. The switches 326 can be relays, hardware contactors, solid-state contactors, and similar components able to enable or disable flow of electricity between an external power source and the power sources of the house electrical system 300.

A controller 328 can be used to manage the switches 326. The controller 328 can be a component within the switch assembly 324 or external to the switch assembly 324. Because the switch assembly 324 has the ability to be connected to multiple external power sources simultaneously, the controller 328 can determine which external power source should be prioritized. Put another way, the controller 328 can control the switches 326 to select different charging modes for charging the power sources 304 of the house electrical system 300.

For example, the controller 328 can detect when the external power source is a charging station capable of providing 240 volts and prioritize the detected external power source over others. As another example, the controller 328 can detect when the external power source is coupled via the second port 302 and prioritize that detected external power source over the power sources 204 from the chassis electrical system 200. This approach can help limit draining the power sources 204 otherwise used for the propulsion system and therefore can extend the available driving range of the recreational vehicle 100.

FIG. 5 shows a more detailed diagram of the switch assembly 324. The switch assembly 324 includes an electrical vehicle supply equipment (EVSE) communication module 330, an electric contactor 332, and current sensors 334A and 334B.

In example shown in FIG. 5, the switch assembly 324 includes two switches 326 that are normally closed such that the default charging mode is to receive power from the 120 volt chassis power source. The charging mode can be changed when the EVSE communication module 330 detects that a charger has been coupled to the second charging port 302. For example, the EVSE communication module 330 can sense that a J1772 charger is connected to the second charging port 302 via a proximity signal. In response, the EVSE communication module 330 can send a signal (e.g., a connection signal, which can be a data signal or a 12 volt signal, for example) to the controller 328. The controller 328 can be programmed to, in response to the signal, energize the electric contactor 332 to switch the switches 326 from the default position to a second position. In the second position, power is received from the second port 302.

The current sensors 334A and 334B detect whether the second port 302 is receiving 120 volts or 240 volts. Although two current sensors are shown in FIG. 5, certain embodiments can use a single current sensor. Once the voltage level is detected, the charging power setting for the charger 320 can be selected/set. In certain embodiments, the charger 320 then converts the AC power to DC power, which is then distributed to components of the house battery system 300.

### Alternative House Electrical System Approaches

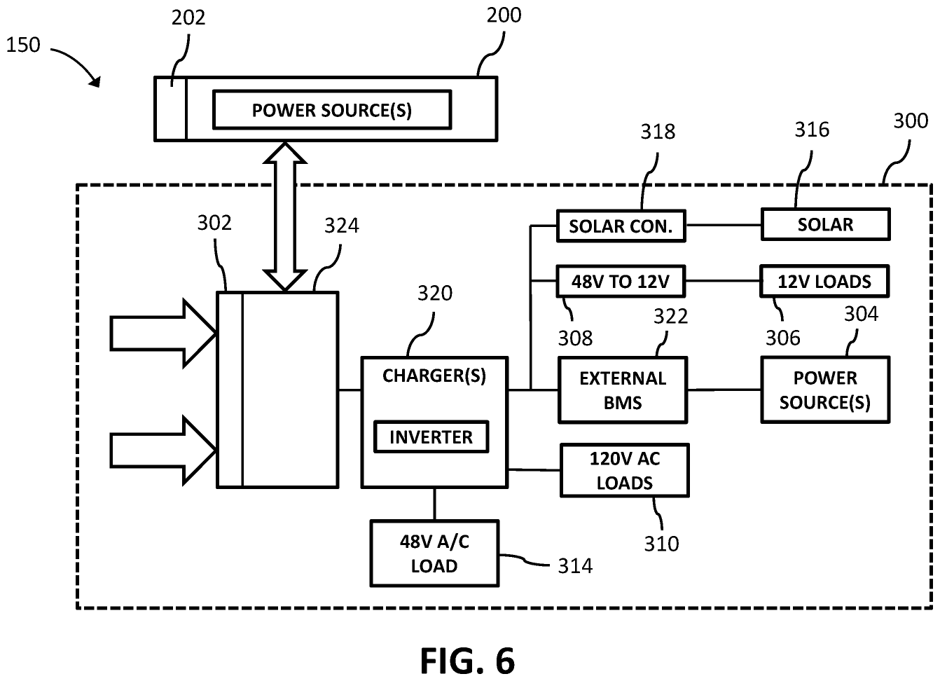

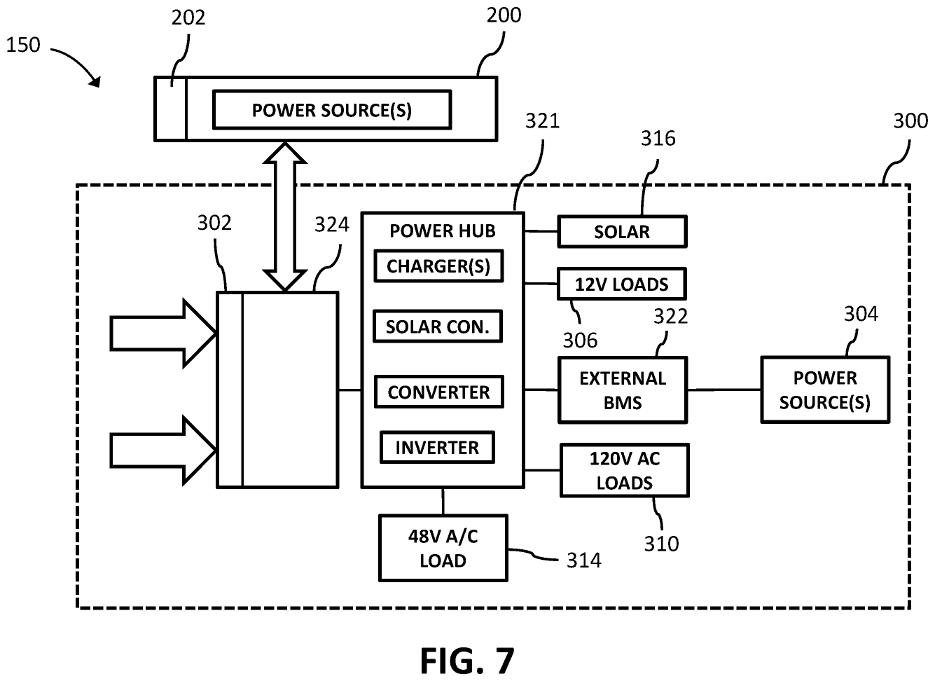

FIGS. 6 and 7 show alternative approaches for the house electrical system 300, where certain functions/components previously shown in FIG. 3 have been consolidated into combined devices.

In FIG. 6, the charger 320 is a combined charger/inverter. As such, the charger 320 itself can assist with charging the power sources 304 but also convert AC power to DC power and vice versa. This approach can eliminate the need for a separate inverter device.

In FIG. 7, multiple components have been consolidated into a power hub 321. The power hub 321 can combine functions of the charger(s), solar controller, converter (e.g., voltage step down/up), and inverter (e.g., converting AC or DC power and vice versa). This approach can eliminate the need for multiple separate devices and package them into an integrated system.

### Computing System

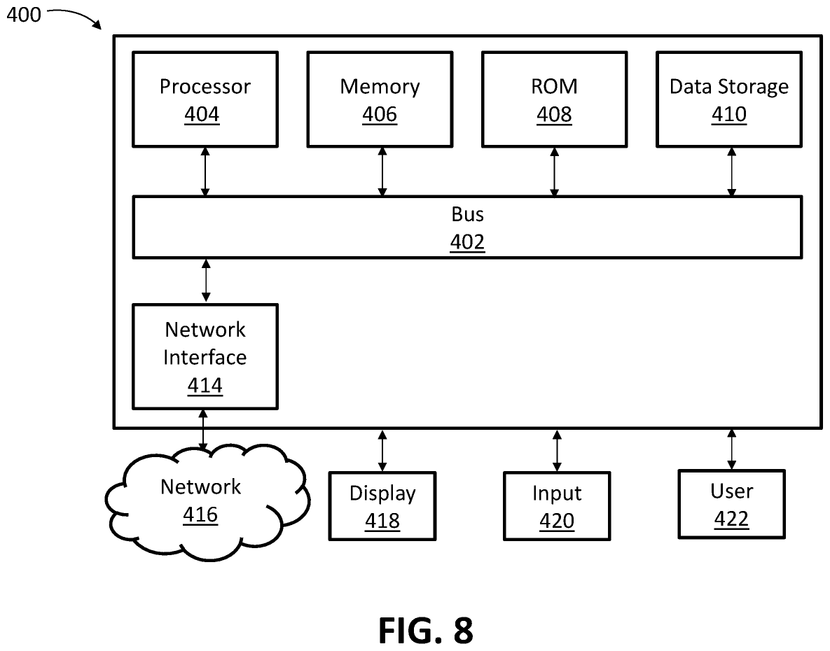

In certain embodiments, the controller 328 and other electrical components described herein (such as the controller of the external BMS 322) can be considered to be a computer or computing system. FIG. 8 shows a block diagram of illustrative components of a computing system 400 for carrying out aspects of the various functions and processed described here. This diagram is merely an example, and the computing systems may have additional or fewer components.

The computing system 400 includes a bus 402 or other communication mechanism for communicating information between or among one or more processors 404 (e.g., microprocessors), memory 406 (e.g., random access memory (RAM), flash memory, and/or other dynamic storage devices), read only memory (ROM) 408, a data storage device 410 (e.g., a hard disk drive, optical disk drive, or solid state drive), and/or a network interface 412.

The processor(s) 404 can execute software and/or firmware stored in the memory 406 of the computing system 400. The software/firmware code contains instructions (e.g., computer code, machine-useable instructions, and the like) that, when executed by the processor 404, cause the computing system 400 to perform the functions described herein. The computing system 400 may alternatively or additionally include one or more application-specific integrated circuits (ASICs), field-programmable gate arrays (FPGAs), digital signal processors (DSPs), hardwired logic, or combinations thereof.

The computing system 400 can also be communicatively coupled to a display 418 and an input device 420. For example, the computing system 400 may be coupled to or physically positioned within a control panel that is positioned within an interior of a recreational vehicle (e.g., attached to a wall or partition of a recreational vehicle). The control panel may include the display 418 and the input device 420. In some embodiments, the display 418 (e.g., an LCD display or a touch screen) is configured to display information to a user. In some examples, the input device 420 (e.g., alphanumeric and other keys) is configured to communicate information and commands to the computing system 400. In some embodiments, the display 418 is a touchscreen and therefore includes input devices 420.

The computing system 400 can also be communicatively coupled to a user device 422 such as a mobile phone or detachable control panel. For example, the user device 422 may include an application (e.g., an app downloaded from an app store) that enables the user device 422 to communicate with the computing system 400 directly or indirectly (e.g., via the network interface 414 and network 416). The user device 422 can have its own display and/or user inputs for sending information and commands to computing system 400.

In certain embodiments, the computing system 400 can communicate with devices, networks, and subsystems that utilize the Controller Area Network (CAN) protocol, SAE J1939 protocol, Local Interconnect Network (LIN) protocol, RV-C protocol, and so on.

Various modifications and additions can be made to the embodiments disclosed without departing from the scope of this disclosure. For example, while the embodiments described above refer to particular features, the scope of this disclosure also includes embodiments having different combinations of features and embodiments that do not include all of the described features. Accordingly, the scope of the present disclosure is intended to include all such alternatives, modifications, and variations as falling within the scope of the claims, together with all equivalents thereof.

We claim:

1. A recreational vehicle comprising:
a body;
a chassis electrical system including a first power source;
a first port coupled to the first power source and attached to the body such that the first port is accessible from outside the recreational vehicle;
a house electrical system including a second power source, wherein the second power source includes a rechargeable battery;
a second port coupled to the second power source and attached to the body such that the second port is accessible from outside the recreational vehicle, wherein the second port is a charging port arranged to directly recharge the second power source; and
a switch assembly electrically coupled between the second port and the second power source and including a controller programmed to switch between charging modes depending on a type of external power source connected to the second port.

2. The recreational vehicle of claim 1, wherein the types of external power source are associated with a voltage level, wherein the controller is programmed to select one of the charging modes based on the voltage level of available external power sources.

3. The recreational vehicle of claim 2, wherein the controller receives an electrical signal indicating the voltage level of the available external power sources.

4. The recreational vehicle of claim 3, wherein the controller is programmed to select the voltage level that is highest among the available external power sources.

5. The recreational vehicle of claim 1, wherein the controller is programmed to prioritize a 240 volt external power source over a 120 volt external power source.

6. The recreational vehicle of claim 1, wherein the second port is a J1772 charging port.

7. The recreational vehicle of claim 1, wherein the second port includes five individual ports for receiving pins of a connector.

8. The recreational vehicle of claim 1, wherein the switching assembly includes multiple individual switches that are controlled by the controller.

9. The recreational vehicle of claim 1, wherein the rechargeable battery is a 48 volt battery.

10. The recreational vehicle of claim 9, wherein the rechargeable battery provides power to 12 volt DC loads, 120 volt AC loads, and 48 volt DC loads.

11. The recreational vehicle of claim 1, further comprising a 120 volt charger and a 240 volt charger electrically coupled between the switching assembly and the rechargeable battery.

12. The recreational vehicle of claim 1, wherein the rechargeable battery is a second rechargeable battery, wherein the charging port is a second charging port, wherein the first port is a first charging port arranged to directly recharge the first power source, wherein the first power source includes a first rechargeable battery.

13. The recreational vehicle of claim 12, wherein the first rechargeable battery is electrically coupled to the switching assembly to selectively provide power to the second rechargeable battery.

14. The recreational vehicle of claim 13, further comprising a DC to AC inverter coupled between the first rechargeable battery and the switching assembly.

15. The recreational vehicle of claim 12, wherein the first rechargeable battery provides power to a propulsion system.

16. The recreational vehicle of claim 12, wherein the second rechargeable battery is electrically coupled to the switching assembly to selectively provide power to the first rechargeable battery.

17. The recreational vehicle of claim 1, wherein the recreational vehicle is a camper van.

18. The recreational vehicle of claim 17, wherein one of the first port and the second port is positioned on a front end of the recreational vehicle, wherein the other one of the first port and the second port is positioned on a side of the recreational vehicle.
